(19) United States
(12) Patent Application Publication
(10) Pub. No.: US 2023/0232807 A1
(43) Pub. Date: Jul. 27, 2023

(54) Fish Finding Mount

(71) Applicant: Tommy Jones, Scottsboro, AL (US)

(72) Inventor: Tommy Jones, Scottsboro, AL (US)

(21) Appl. No.: 17/584,131

(22) Filed: Jan. 25, 2022

(51) Int. Cl. A01K 97/12

(52) U.S. Cl. CPC A01K 97/125

(57) ABSTRACT

A bracket for holding a fish finder has a horizontal attachment arm and horizontal attachment arm couples to a trolling motor. The bracket also has an offset bar coupled to the horizontal attachment arm at an angle, an arm integral with an end of the offset bar, the arm extending upward and at the angle, and a holder attached to end of the arm for holding a fish finder.

### BACKGROUND

Oftentimes anglers use a trolling motor when fishing from a boat. The trolling motor is a self-contained unit. Typically, the trolling motor comprises an electric motor, propeller, and controls. The trolling motor is affixed to the boat either at the bow or stern. In use, the angler uses a foot control to control speed of the boat and on/off. Further, the trolling motor comprises a hand controller for steering, with speed control built into a tiller or a control knob on top of the trolling motor.

In addition, anglers use fish finders. In this regard, a fish finder is an instrument to aid the angler in finding fish beneath the water. The fish finder detects reflected pulses of sound energy via sonar. Fish finders comprise a display that displays measurements of reflected sound on a graphical user interface (GUI). The GUI allows the angler to interpret information to locate schools of fish, underwater debris, and the floor of the body of water.

Often, a trolling motor and a fish finder are paired together. This provides the angler more time for casting, jigging, trolling, changing lures tying lines, and cutting bait. Trolling motors and fish finder combinations utilize global positioning system (GPS) technology, which allows the angler to free himself from needing to be in constant control of the boat by inputting routes for the boat to follow.

### DESCRIPTION OF DRAWINGS

The present disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the views.

FIG. 1 is a is a perspective view of a trolling motor attached to a fish finder and coupled to a stern of a boat in accordance with and embodiment of the present disclosure.

FIG. 2 is a side view of the trolling motor and the fish finder of FIG. 1 wherein the fish finder is stowed on a bracket.

FIG. 3 is perspective view of the bracket such as is shown in FIG. 1.

FIG. 4 is a perspective view of the bracket such as is shown in FIG. 1.

FIG. 5 is a side view of the bracket such as is shown in FIG. 1.

FIG. 6 is a top view of the bracket such as is shown in FIG. 1.

### DETAILED DESCRIPTION

The present disclosure describes a fish finder mount in accordance with an embodiment of the present disclosure. The fish finder is mounted to a trolling motor. A bracket is coupled to a side of the trolling motor, and the fish finder may be coupled to the bracket while the fish finder is not in use.

In one embodiment, the trolling motor is a Minn Kota. The Minn Kota trolling motor has a 72-in shaft and 80 lbs. of thrust, and this trolling motor works well with any fishing boat. The Minn Kota trolling motor has its own autopilot and global positioning system (GPS) spot lock along with an i-Pilot link integrated Integrated GPS trolling system.

In one embodiment, the fish finder is a Humminbird Helix 9 that uses dual spectrum compressed high intensity radar purse (CHIRP) sonar. This type of Humminbird Helix fish finder has a built-in internal GPS and uses the Humminbird enhanced base map.

Note that the Minn Kota trolling motor is merely an exemplary trolling motor. Other trolling motors may be used in other embodiments. Also Note that the Humminbird Helix is also merely an exemplary fish finder. Other fish finders may be used in other embodiments.

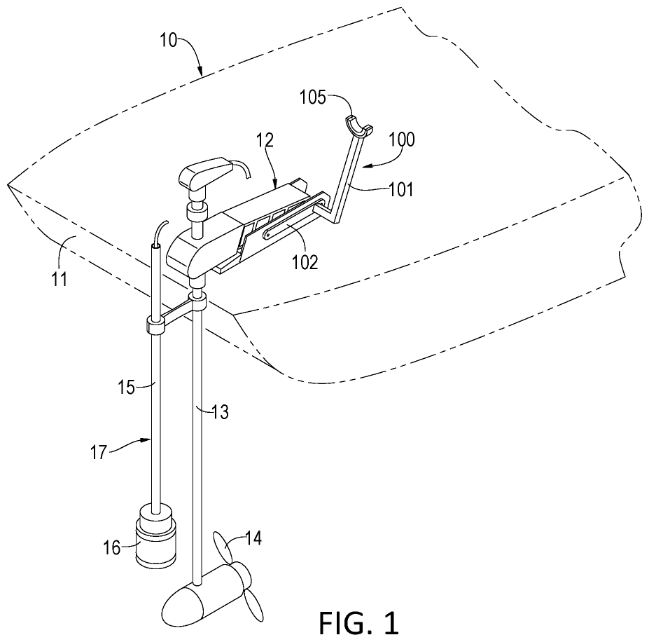

FIG. 1 is a perspective view of a boat. Mounted on the boat is a trolling motor 12. The trolling motor 12 allows a boat to stay in one spot when fighting against current or wind without deploying a physical anchor. if one tilts the outboard engine out of the water, he may use the trolling motor to explore areas that are otherwise too shallow too access.

The trolling motor 12 comprises a motor (not shown). The motor controls a propeller 14. Thus, an angler, via actuation of controls (not shown), can control the propeller to stay in one spot without the use of an anchor. The trolling motor comprises a shaft 13 that couples the motor to the propeller. Control of the trolling motor 12 may be accomplished via a handheld device having controls (not shown) or a foot pedal (not shown). The trolling motor 12 is fixedly coupled to a stern 11 of a boat 10. Note that the trolling motor 12 may also be coupled to a bow of the boat 10.

Coupled to the trolling motor 12 is a fish finder 17. The fish finder 17 comprises a shaft 15. Electronics and a sonar device are encapsulated in the head 16. In operation, data received via the sonar device is transmitted to a display device (not shown), which may show schools of fish, underwater debris, and/or the bottom of the body of water.

When the fish finder 17 is not in use, the fish finder 17 can be stowed on a bracket 100. The bracket 100 is mounted to the trolling motor 12. In this regard, the mounting bracket 100 comprises a horizontal attachment arm 102 that attaches the bracket to the trolling motor 12. The horizontal attachment arm 102 may comprise openings through which fasteners may be inserted to attach the bracket to the trolling motor 100.

Extending from the horizontal attachment arm 102 is an offset bar 103 that protrudes away from the trolling motor 12. The offset bar 103 is attached to the horizontal attachment arm 102 at an angle. The offset bar angle is less than 90°; however other angles may be used in other embodiments.

The bracket 100 further comprises an arm 104 integral with an end of the offset bar 103. The arm 104 extends away from the offset bar 103 at an obtuse angle relative to the horizontal attachment arm 102.

Coupled to an end of the arm 104 is an arched terminator 105. The arched terminator 105 is arched upward. Thus, the arched terminator 105 may interface with and hold the shaft 15 and the head 16 of the fish finder 17.

When the shaft 15 and the head of the fish finder 17 is secured to the arched terminator 105, the bracket 100 provides stability to the trolling motor 12. That is, when the trolling motor 12 is removed from the water and the fish finder 17 is secured to the arched terminator when the boat is in motion on water. The bracket 100 also provides stability to the trolling motor 17 when the boat is being transported.

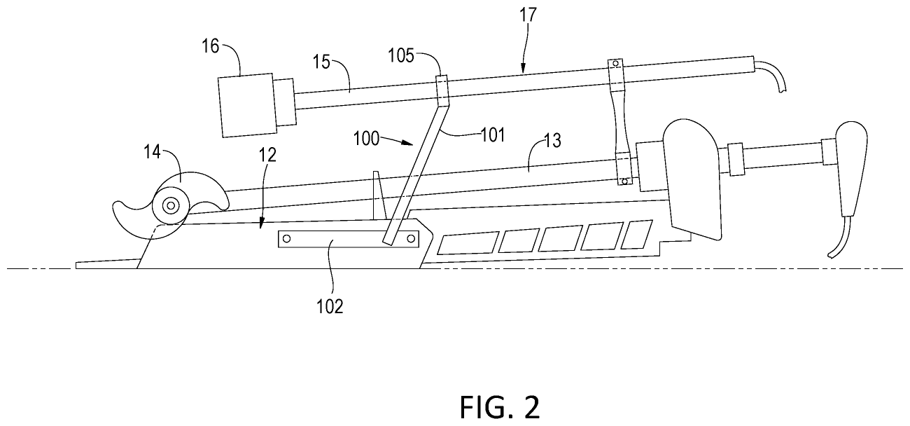

FIG. 2 is a side view of the trolling motor 12 in a stowed position. In this regard the shaft and propeller 14 rests atop the trolling motor 12. When the trolling motor 12 is in a stowed position, the fish finder 17 may also be in a stowed position.

For stowing, the bracket 100 is coupled to the side of the trolling motor 12. The bracket 100 comprises the horizontal attachment arm 102. The horizontal attachment arm 102 is coupled to the trolling motor via fasteners (not shown), such as, for example, screws.

The bracket 100 further comprises an arm 104 integral with and end of the offset bar 103 (FIG. 1). The arm 104 extends away from the offset bar 103 at the angle of the offset bar 103. Thus, the arm 104 is at an obtuse angle relative to the horizontal attachment arm 102. In one embodiment, the offset bar angle is less than 90°; however other angles may be used in other embodiments.

Coupled to an end of the arm 104 is an arched terminator 105. The arched terminator 105 is arched upward. Thus, the arched terminator 105 may interface with and hold the shaft 15 and the head 16 of the fish finder 17.

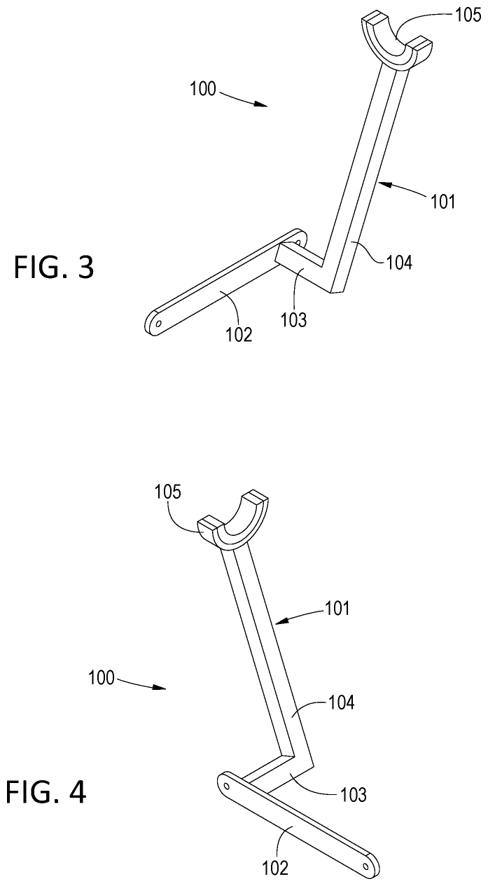

FIG. 3 is a perspective view of the bracket 100. When the fish finder 17 is not in use, the fish finder 17 can be stowed on the bracket 100. The bracket 100 is mounted to the trolling motor 12. In this regard, the mounting bracket 100 comprises a horizontal attachment arm 102 that attaches the bracket to the trolling motor 12. The horizontal attachment arm 102 may comprise openings through which fasteners may be inserted to attach the bracket to the trolling motor 100.

Extending from the horizontal attachment arm 102 is an offset bar 103 that protrudes away from the trolling motor 12. The offset bar 103 is attached to the horizontal attachment arm 102 at an angle. In one embodiment, the offset bar angle is less than 90°; however other angles may be used in other embodiments.

The bracket 100 further comprises an arm 104 integral with and end of the offset bar 103. The arm 104 extends away from the offset bar 103 at the angle of the offset bar 103.

Coupled to an end of the arm 104 is an arched terminator 105. The arched terminator 105 is arched downward. Thus, the arched terminator 105 may interface with and hold the shaft 15 and the head 16 of the fish finder 17.

FIG. 4 is another perspective view of the bracket 100. When the fish finder 17 is not in use, the fish finder 17 can be stowed on the bracket 100. The bracket 100 is mounted to the trolling motor 12. In this regard, the mounting bracket 100 comprises a horizontal attachment arm 102 that attaches the bracket to the trolling motor 12. The horizontal attachment arm 102 may comprise openings through which fasteners may be inserted to attach the bracket to the trolling motor 100.

Extending from the horizontal attachment arm 102 is an offset bar 103 that protrudes away from the trolling motor 12. The offset bar 103 is attached to the horizontal attachment arm 102 at an angle. In one embodiment, the offset bar angle is less than 90°; however other angles may be used in other embodiments.

The bracket 100 further comprises an arm 104 integral with and end of the offset bar 103. The arm 104 extends away from the offset bar 103 at the angle of the offset bar 103.

Coupled to an end of the arm 104 is an arched terminator 105. The arched terminator 105 is arched downward. Thus, the arched terminator 105 may interface with and hold the shaft 15 and the head 16 of the fish finder 17.

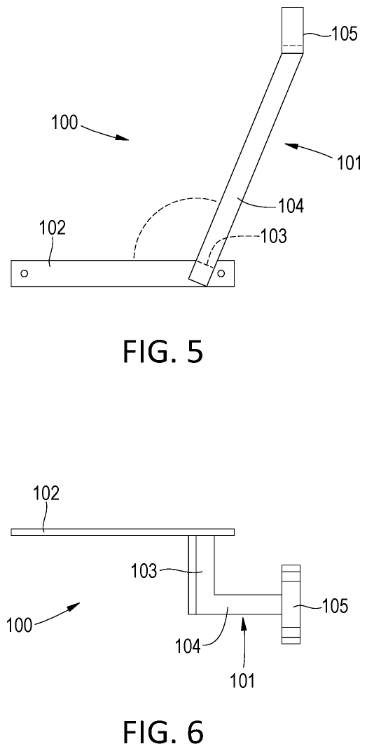

FIG. 5 is side view of the bracket 100. When the fish finder 17 is not in use, the fish finder 17 can be stowed on the bracket 100. The bracket 100 is mounted to the trolling motor 12. In this regard, the mounting bracket 100 comprises a horizontal attachment arm 102 that attaches the bracket to the trolling motor 12. The horizontal attachment arm 102 may comprise openings through which fasteners may be inserted to attach the bracket to the trolling motor 100.

Extending from the horizontal attachment arm 102 is an offset bar 103 (FIG. 3) that protrudes away from the trolling motor 12. The offset bar 103 is attached to the horizontal attachment arm 102 at an angle. In one embodiment, the offset bar angle is less than 90°; however other angles may be used in other embodiments.

The bracket 100 further comprises an arm 104 integral with an end of the offset bar 103. The arm 104 extends away from the offset bar 103 at the angle of the offset bar 103. Note that the arm 104 is perpendicular to the offset bar 103. The arm 104 extends at an obtuse angle from the horizontal attachment bar 102.

Coupled to an end of the arm 104 is an arched terminator 105. The arched terminator 105 is arched downward. Thus, the arched terminator 105 may interface with and hold the shaft 15 and the head 16 of the fish finder 17.

FIG. 6 is a top view of the bracket 100. The horizontal attachment arm 102 is coupled to the offset bar 103. The offset bar 103 is integral with the arm 104. The arm 104 is coupled to the arched terminator 105.

What I claim is:

1. A bracket for holding a fish finder comprising,
a horizontal attachment arm, the horizontal attachment arm configured for coupling to a side of a trolling motor;
an offset bar coupled to the horizontal attachment arm at an angle;
an arm integral with an end of the offset bar, the arm extending upward at an obtuse angle relative to the horizontal attachment arm; and
an upward arch holder attached to an end of the arm for holding a fish finder.

2. The bracket for holding a fish finder of claim 1, coupled to the trolling motor.

3. The bracket for holding a fish finder of claim 2, wherein the fish finder is coupled to the trolling motor.

4. The bracket for holding a fish finder of claim 1, wherein an angle between the horizontal attachment arm and the arm integral with an end of the offset bar is greater than ninety degrees.
